(19) United States
(12) Patent Application Publication
(10) Pub. No.: US 2007/0165981 A1
(43) Pub. Date: Jul. 19, 2007

(54) Optical component for optical communication

(76) Inventors: Hirokazu Tanaka, Otsu-shi (JP); Masanori Wada, Otsu-shi (JP); Masaaki Kadomi, Otsu-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/634,952

(22) Filed: Dec. 7, 2006

(30) Foreign Application Priority Data
Jan. 18, 2006 (JP) 2006-010054

(51) Int. Cl. G02B 6/32

(52) U.S. Cl. 385/33; 385/34; 385/35

(57) ABSTRACT

Provided is an optical component for optical communication which is capable of suitably accepting a request to reduce a size, resisting a thermal expansion coefficient difference between constituent elements, and adjusting incident and exit modes relative to an end of an optical fiber to thereby constantly attain optical characteristics which correspond to the request. The optical component includes a fiber holding member (3) holding an optical fiber (2), and a lens (4) which is located on an optical path extending from an end of the optical fiber (2) and attached to the fiber holding member (3). A flat portion (4a) formed in a rear end of the lens (4) is bonded to be fixed to a flat portion (6a) of an end of the fiber holding member (3) such that the flat portion (4a) of the lens (4) is opposed to the end of the optical fiber (2). A gap is provided between the flat portion (4a) of the lens (4) and the end (2a) of the optical fiber (2).

### BACKGROUND OF THE INVENTION

1. Field of the Invention

The present invention relates to an optical component for optical communication, and more particularly, to a technique for suitably fixing a lens to a fiber holding member for holding an optical fiber.

2. Description of the Related Art

As has been generally known in the field of optical communication, there has been frequently used an optical module including, for example, a semiconductor light emitting element such as a laser diode, a semiconductor light receiving element such as a photo diode, and an optical fiber which are optically coupled to each other. A component widely used for constructing such the optical module or another optical module similar there to is an optical component for optical communication which includes a fiber holding member for holding an optical fiber in an inner hole and a lens which is located on an optical path extending from an end of the optical fiber and attached to the fiber holding member.

According to JP 2003-315610 A, JP 2003-315612 A, JP 2003-344697 A, and JP 2003-344698 A, a known example of this kind of optical component for optical communication includes an optical collimator constructed so as to convert light (light signal) which is outputted from the optical fiber and spread out into parallel light or so as to focus the parallel light onto an end of the optical fiber. Under the present circumstances in which studies have been made for increasing the density of an optical fiber communication device in order to effectively use a limited space in which the device is set, along with the spread of optical fiber communication systems, there has been a demand for reduction of the size of the optical collimator used in an inner portion of the device and achievement of high performance of the optical collimator.

FIGS. 5A to 5C show examples of three kinds of optical collimators which have been normally used in the present circumstances. In each of the optical collimators 1X, a refractive index distribution type GRIN lens 4X (see FIG. 5A), a C-lens 4Y having a uniform refractive index (see FIG. 5B), or a drum lens 4Z whose both axial end surfaces are convex (see FIG. 5C) is inserted into one end side of an inner hole of a sleeve 6X. A ferrule (or a receptacle) 5X for holding an optical fiber 2X in an inner portion thereof is inserted into the other end side of the inner hole so as to be brought close to the inserted lens. In this case, in order to prevent the generation of reflection return light at an end surface of the optical fiber 2X, an end surface 5Xa of the ferrule 5X is obliquely polished to form an oblique surface. In addition, in order to accurately and certainly operate the optical collimator 1X, the ferrule 5X and each of the lenses 4X and 4Y and 4Z are centered to obtain a suitable optical positional relationship therebetween and then fixed to the inner hole (inner circumference surface) of the ferrule 5X by a bonding agent.

Another example of the above mentioned optical component for optical communication includes, in addition to the optical collimator, a semiconductor laser module disclosed in JP 02-216109 A in which an end of a single-mode optical fiber is connected with a multi-mode optical fiber and an end surface of the multi-mode optical fiber is formed in a spherical shape to have a lens effect, which has been put in trial or practical use.

In the structure in which each of the lenses 4X, 4Y, and 4Z and the ferrule 5X are inserted into the inner hole of the sleeve 6X and fixed thereto, such as the structure of the optical collimator X1 shown in each of FIGS. 5A, 5B, and 5C, it is necessary to prevent the bonding agent from wrapping around an optical axis to thereby avoid a high-power laser light beam from causing damage to the bonding agent. In addition, in order to obtain a stable environment resistance characteristic, a certain bonding area is necessary. Therefore, each of the lenses 4X, 4Y, and 4Z is formed in a cylindrical shape capable of bearing a large bonding area.

In this case, in order to respond to the demand for reduction of the size of the optical collimator in recent years, it is only necessary for the GRIN lens 4X shown in FIG. 5A to be made small in a cylindrical diameter and in the entire length. In such the simple method, however, in order to reduce a beam diameter of collimated light (parallel light) to a small diameter, an extremely steep refractive index gradient is required, which is substantially impossible to be attained in view of cost and manufacture procedure. In the case where a cylindrical diameter and the entire length of each of the C-lens 4Y and the drum lens 4Z shown in FIGS. 5B and 5C, respectively, are shortened, a curved surface having a small curvature radius needs to be formed in an end surface of a cylinder in order to reduce the beam diameter of collimated light to the small diameter. However, it is technically very difficult to form such the curved surface whose curvature radius is equal to or smaller than the radius of the cylinder in the end surface by polishing. In view of the above-mentioned circumstances, each of the three kinds of lenses 4X, 4Y, and 4Z has a problem in that the beam diameter of the collimated light is limited by the cylindrical diameter and thus it is impossible to suitably meet the demand for reduction of the size of the optical collimator 1X.

There is a thermal expansion coefficient difference among the sleeve 6X, each of the lenses 4X, 4Y, and 4Z, and the ferrule 5X. Therefore, because of the fact that each constituent element cannot be reduced in size, the amount of expansion or the amount of contraction of each constituent element is significantly changed by a variation in temperature during the use of the optical collimator, which may cause deviations in optical characteristics. In particular, when a stress is concentrated on each of the lenses 4X, 4Y, and 4Z due to the thermal expansion coefficient difference, there occurs a problem of an increase in the number of troubles resulting from the deviations in optical characteristics including a refractive index and light dispersion, leading to a deterioration of optical system stability. In addition to this, under the condition where the temperature rises or falls to a temperature significantly different from a room temperature, a bonding portion between the sleeve 6X and a combination of the ferrule 5X and each of the lenses 4X, 4Y, and 4Z is peeled to deteriorate essential part characteristics. Further, each of the lenses 4X, 4Y, and 4Z is distorted to change the amount of transmitted light or polarization characteristics, and stable collimated light cannot be obtained. As a result, a use environment of this kind of optical component for optical communication is excessively limited. In particular, an outdoor use is significantly limited. In addition, when the optical collimator is incorporated in an optical device, high-precision optical characteristics are required. Therefore, there is a problem that a usable temperature range extremely narrows and thus the limitation at the time of use becomes even tighter.

As disclosed in JP 02-216109 A, another example of the optical component for optical communication, in addition to the optical collimator, is the semiconductor laser module in which a rear end surface of the multi-mode optical fiber is bonded to be fixed to the end surface of the single-mode optical fiber, and the end surface of the multi-mode optical fiber is formed in the spherical shape to have the lens effect. In the semiconductor laser module, the optical fibers whose refractive indexes are equal to each other are connected with each other. Therefore, the end surfaces of the optical fibers are in close contact with each other without any gap therebetween. According to such the structure, in the case of the optical component for optical communication in which, for example, optical characteristics are significantly influenced by an exit mode of light outputted from the end of an optical fiber and an incident mode of light incident on the end of the optical fiber, as represented by the above-mentioned optical collimator, the incident and exit modes of the light which is incident on and outputted from the end of the optical fiber cannot be adjusted at all. Accordingly, at the time of coupling the optical fiber and the lens to each other or after the optical fiber and the lens are coupled to each other, it is impossible to (finely) adjust the optical characteristics to have desirable characteristics even if there is such the request. Thus, slight deviations or the like is caused in optical characteristics, which leads to a critical problem in that an optical component for optical communication for which desirable optical characteristics cannot be attained must be used without any adjustment, or such the optical component must be discarded as useless.

### SUMMARY OF THE INVENTION

The present invention has been made in view of the above-mentioned circumstances. The present invention has a technical object to provide an optical component for optical communication which is capable of suitably responding to a demand for reduction of a size thereof, resisting to a thermal expansion coefficient difference between respective constituent elements, and adjusting incident and exit modes of light which is incident on and outputted from an end of an optical fiber, to thereby constantly obtain optical characteristics capable of responding to the demand.

According to the present invention which has been made to attain the above-mentioned technical object, there is provided an optical component for optical communication including: a fiber holding member for holding an optical fiber; and a lens which is located on an optical path extending from an end of the optical fiber and attached to the fiber holding member, in which a flat portion formed in a rear end of the lens is bonded to be fixed to a flat portion formed in an end of the fiber holding member such that the flat portion of the lens is opposed to the end of the optical fiber, and a gap is provided between the flat portion of the lens and the end of the optical fiber. In this case, it is preferable that the flat portion of the lens be bonded to be fixed to the flat portion of the fiber holding member so as to be perpendicular to an optical axis of the optical fiber.

According to the above-described structure, the flat portion formed in the end of the fiber holding member for holding the optical fiber is bonded to be fixed to the flat portion formed in the rear end of the lens. In other words, the lens is provided adjacent to the end of the fiber holding member in a state in which the flat portions are bonded to each other. As a result, it is unlikely that a shape and a size of the lens are influenced by another constituent element such as the fiber holding member. Therefore, the degree of freedom of lens design can be increased, which makes it possible to reduce the size of the lens and to form a curved surface whose curvature radius is small. Thus, it is unlikely to limit optical characteristics including a beam diameter, with the result that preferable optical characteristics can be obtained. In addition, it is unlikely that the fiber holding member is limited in terms of, for example, the size of the lens, so a size of the fiber holding member can be reduced. Therefore, the entire size of the optical component for optical communication is reduced with the reduction in size of the lens. Further, even when there is a thermal expansion coefficient difference between the lens and the fiber holding member, interference therebetween is suppressed from being caused by expansion or contraction thereof. In particular, a problem is solved by preventing a stress from concentrating on the lens and deviations from being caused in optical characteristics such as a refractive index and light dispersion, so stable optical characteristics can be obtained. Therefore, a use environment of the optical component for optical communication is not excessively limited and it is unlikely to limit an outdoor use thereof. In addition to this, when the optical component is incorporated into an optical device, a temperature range in which the optical device can be used is significantly widened while high-precision optical characteristics are maintained. Furthermore, due to the gap provided between the flat portion of the lens and the end of the optical fiber in a state in which the flat portion of the lens is opposed to the end of the optical fiber, the end of the optical fiber can be freely positioned by adjusting a distance between the flat portion of the lens and the end of the optical fiber as appropriate. Therefore, an exit mode of light outputted from the end of the optical fiber and an incident mode of light incident on the end of the optical fiber can be adjusted to be in a suitable state. Thus, it is possible to suitably respond to a request to (finely) adjust the optical characteristics to have desirable characteristics at the time of coupling the optical fiber and the lens to each other or after the optical fiber and the lens are coupled to each other, to thereby constantly ensure the best optical characteristics. Furthermore, the flat portion of the lens and the end of the optical fiber are separated from each other with the gap provided therebetween, which makes it possible to suppress reflection return light generated between the lens and the optical fiber from being incident on the lens side.

In an optical component for optical communication with the above-described structure, the optical component for optical communication preferably includes an optical collimator for converting light which is outputted from the optical fiber and spread out into parallel light through the lens or for focusing parallel light on the optical fiber through the lens.

Therefore, when the optical component for optical communication includes the optical collimator, as described above, advantages is significantly obtained in that, for example, the size of the optical collimator is reduced along with reductions in sizes of the lens and the fiber holding member, the problem is prevented from being caused by the thermal expansion coefficient difference between the lens and the fiber holding member, and light incident on the end of the optical fiber and light outputted therefrom are suitably adjusted due to the gap provided between the flat portion of the lens and the end of the optical fiber. In addition to this, it is possible to obtain an advantage that collimated light (parallel light) with a small beam diameter is produced.

According to the structure described above, the optical fiber preferably includes an oblique surface, in the end thereof, tilted relative to an optical axis.

With the optical fiber described above, reflection light on an end surface of the optical fiber can be released to the outside of the optical axis, which reduces noise and increases the amount of transmitted light. As a result, long-distance transmission is possible.

In the case where the optical component for optical communication includes the optical collimator, a minimum value of a beam diameter of the parallel light is preferably equal to or smaller than 200 μm.

With the optical collimator described above, the beam diameters of the parallel light which is incident on the optical fiber and has yet to pass through the lens and of the parallel light which is outputted from the optical fiber and has passed through the lens both become vary small, which makes it possible to reduce a size of an optical system while ensuring preferable beam characteristics. The reason why the beam diameter of the parallel light can be reduced to a small diameter (more preferably 141 μm or less, further preferably 100 μm or less) is based on a specific structure of the optical component for optical communication according to the present invention as described above. Note that, for example, a beam diameter of parallel light from the conventional normal optical collimator shown in FIGS. 5A, 5B, or 5C has been approximately 400 μm.

According to the structure described above, it is preferable that the fiber holding member include: a first holding member including an inner hole for holding the optical fiber therein; and a second holding member which is fitted to an outer circumference side of the first holding member and includes a flat portion formed in an end of the second holding member and a flat portion formed in the rear end of the lens, and that the flat portion formed in the rear end of the lens is preferably bonded to be fixed to the flat portion formed in the end of the second holding member such that the flat portion of the lens is opposed to an end of the first holding member.

With the above-described structure, the first holding member (such as a ferrule) holding the optical fiber in the inner hole can be held by the second holding member (such as a sleeve) so as to be movable in an optical axis direction, the second holding member being located on the outer circumference side of the first holding member. Thus, when the first holding member is moved in the optical axis direction relative to the second holding member, a separation distance between the end of the optical fiber and the flat portion of the lens can be adjusted, with the result that the adjustment operation is facilitated and an fitting operation such as axis alignment can be efficiently and accurately performed.

According to the structure described above, it is preferable that the first holding member include an oblique surface tilted relative to an optical axis in the end thereof and the oblique surface is formed to be identical to the oblique surface formed in the end of the optical fiber.

With the above-described structure, when the end of the first holding member is processed by polishing or the like to form the oblique surface in a state in which the optical fiber is held in the inner hole of the first holding member, the end of the optical fiber can also be simultaneously processed by polishing or the like to form the oblique surface. Thus, the oblique surface having a desirable angle can be easily formed in the end of the optical fiber whose diameter is very small.

According to the structure described above, the lens preferably includes an end surface which includes a convex curved surface.

With the above-described structure, it is possible to accurately form the convex curved surface having a desirable curvature radius in the end of the lens to thereby obtain a lens effect corresponding to a request, without being influenced by another constituent element.

In this case, the convex curved surface of the lens preferably includes a spherical surface.

With the spherical surface, it is easy to control the curvature in forming the curved surface in the end of the lens, which makes the manufacture of the lens easy.

Further, it is preferable that the lens include a spherical lens which is partially processed.

With the lens described above, it is only necessary to form, for example, the flat portion by polishing processing or the like after the spherical lens is manufactured. Thus, the curvature is more easily controlled, so the lens is more easily manufactured.

In addition, it is preferable that the flat portion of the lens be separated from an end vertex of a spherical portion thereof at a distance L which is a length equal to or longer than a radius R of the spherical lens.

With the above-described structure, it is possible to effectively prevent a sharp-edged portion from being formed in the lens. Thus, for example, in the case where the lens is fitted to the fiber holding member, it is easy to grasp the lens by using a grasping member such as tweezers, so the handling of the lens can be facilitated while the lens is prevented from being damaged or from slipping.

Also, it is preferable that at least a light transmitting surface of the flat portion of the lens and/or at least a light transmitting surface of the end surface of the lens be subjected to antireflective coating.

With the above-described structure, a noise caused by reflection return light on the lens is reduced, leading to a significant advantage in the case of stable high-speed optical communication.

Further, it is preferable that the lens include a glass material whose refractive index is equal to or larger than 1.7.

With the lens described above, it is possible to obtain the lens which has the curved surface whose curvature radius is minimum within a range in which the surface can be actually formed and which is capable of reducing the beam diameter. Note that a refractive index of normal optical glass is approximately 1.5. When the refractive index is equal to or larger than 1.7, an advantage can be obtained in that the influence of spherical aberration is reduced to thereby improve coupling efficiency.

According to the structure described above, a coating tube may also be provided to be fitted to an outer circumference side of the fiber holding member and an outer circumference side of the lens therealong, in which an outer diameter of the fiber holding member may be substantially equal to an outer diameter of the lens.

With the above-described structure, the coating tube is fitted to the outer circumference sides of both the fiber holding member and the lens, so the fiber holding member and the lens are coaxially positioned easily. Thus, the simplification of centering and the automation thereof can be easily performed.

As described above, according to the optical component for optical communication of the present invention, the lens is provided adjacent to the end of the fiber holding member in a state in which the flat portions are bonded to each other. As a result, it is unlikely that the shape and the size of the lens are influenced by another constituent element such as the fiber holding member. Therefore, the degree of freedom of lens design increases and it is unlikely that the optical characteristics including the beam diameter are limited, with the result that the preferable optical characteristics can be obtained. In addition, it is unlikely that the fiber holding member is limited by, for example, the size of the lens, so the size of the fiber holding member can be reduced. Therefore, the entire size of the optical component for optical communication is reduced along with the reduction in size of the lens. Further, even when there is the thermal expansion coefficient difference between the lens and the fiber holding member, the interference therebetween due to the expansion or contraction thereof is suppressed. In particular, a problem is solved by preventing a stress from being concentrated on the lens to cause deviations in optical characteristics such as a refractive index and light dispersion. Therefore, the use environment of the optical component for optical communication is not excessively limited. In addition to this, a usable temperature range can be significantly widened while high-precision optical characteristics are maintained when the optical component is incorporated into an optical device. Furthermore, the gap is provided between the flat portion of the lens and the end of the optical fiber in a state in which the flat portion of the lens is opposed to the end of the optical fiber, so a distance between the flat portion of the lens and the end of the optical fiber can be adjusted as appropriate to freely position the end of the optical fiber. Therefore, in the case where there is a request to (finely) adjust the optical characteristics to desirable characteristics at the time when the optical fiber and the lens are to be coupled to each other or after the optical fiber and the lens are coupled to each other, the request can be suitably accepted, to thereby constantly ensure best optical characteristics. Furthermore, the flat portion of the lens and the end of the optical fiber are separated from each other with the gap, so reflection return light caused between the lens and the optical fiber can be prevented form being incident on the lens side.

### BRIEF DESCRIPTION OF THE DRAWINGS

In the accompanying drawings:

FIG. 1 is a longitudinal cross sectional side view showing a schematic structure of an optical component for optical communication according to a first embodiment of the present invention;

FIG. 2 is a longitudinal cross sectional side view showing a schematic structure of an optical component for optical communication according to a second embodiment of the present invention;

FIG. 3 is a longitudinal cross sectional side view showing a schematic structure of an optical component for optical communication according to a third embodiment of the present invention;

FIG. 4 is a longitudinal cross sectional side view showing a schematic structure of an optical component for optical communication according to a fourth embodiment of the present invention; and

FIGS. 5A, 5B, and 5C are longitudinal cross sectional side views showing schematic structures of conventional optical components for optical communication.

### DETAILED DESCRIPTION OF THE PREFERRED EMBODIMENTS

Hereinafter, embodiments of the present invention will be described with reference to the accompanying drawings.

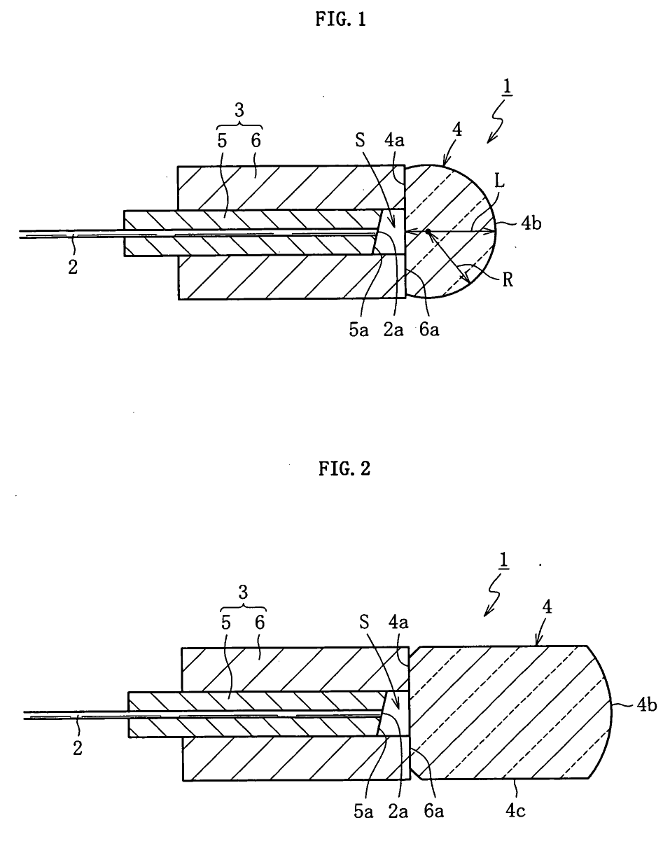

FIG. 1 shows an example of a schematic structure of an optical collimator serving as an optical component for optical communication according to a first embodiment of the present invention. As shown in FIG. 1, an optical collimator 1 includes a fiber holding member 3 for holding an optical fiber 2, and a lens 4 which is located on an optical path extending from an end of the optical fiber 2 and attached to an end of the fiber holding member 3. In this case, the fiber holding member 3 includes a first cylindrical holding member (ferrule) 5 for fixedly holding the optical fiber 2 in an inner hole thereof and a second cylindrical holding member (sleeve) 6 which is held on an outer circumference side of the first holding member 5 and coaxially fitted thereto. The second holding member 6 has an end surface formed to be a flat portion 6a orthogonal to an optical axis (optical axis of the optical fiber 2). The lens 4 has a rear end surface formed to be a flat portion 4a orthogonal to the optical axis. The flat portion 4a of the lens 4 is bonded to be fixed to the flat portion 6a of the second holding member 6 by a bonding agent such that the flat portion 4a is opposed to an end of the first holding member 5 with a gap S provided therebetween. The flat portion 6a of the second holding member 6 is formed with a precision within ±0.5 degrees, preferably ±0.1 degrees, relative to the normal to the optical axis.

The end surface of the first holding member 5 is tilted relative to the optical axis to obtain an oblique surface 5a. The oblique surface 5a is formed so as to flush with an oblique surface 2a which is an end surface of the optical fiber 2. To be specific, the optical fiber 2 is fixedly held in the inner hole of the first holding member 5. In this state, the end of the optical fiber 2 and the end of the first holding member 5 are obliquely polished, so the end surface of the optical fiber 2 is formed to be the oblique surface 2a. Therefore, the generation of reflection return light at the end of the optical fiber 2 is suppressed. The oblique surface 2a of the end of the optical fiber 2 has a light transmitting portion subjected to antireflective coating. The gap S is provided between the oblique surface 2a of the end of the optical fiber 2 and the flat portion 4a of the lens 4, so the first holding member 5 can be moved relative to the second holding member 6 in an axis direction to position the end of the optical fiber 2.

On the other hand, the lens 4 has a convex curved portion (spherical portion) 4b formed on an end side of the lens 4, that is, a side opposed to the flat portion 4a of the lens 4. The spherical portion 4b is a residual portion obtained after a part of a spherical lens produced in advance as an original lens is removed by polishing processing or the like to form the flat portion 4a. A distance L between the flat portion 4a of the lens 4 and an end vertex of the spherical portion 4b is set to be longer than a radius R of the spherical lens which is the original lens. An outside diameter (maximum outside diameter about the optical axis) of the lens 4 is larger than a diameter of the inner hole of the first holding member 5. In this embodiment, the outside diameter of the lens 4 and the outside diameter of the first holding member 5 are substantially equal to each other. The lens 4 is made of optical glass whose refractive index is high and substantially uniform, such as MK-18 (which is produced by Nippon Electric Glass Co., Ltd.) whose refractive index is equal to or larger than 1.7 or RH-21 (which is produced by Nippon Electric Glass Co., Ltd.) whose refractive index is equal to or larger than 1.9. Therefore, not only a size and a diameter of the optical collimator 1 but also the influence of spherical aberration are reduced to improve coupling efficiency. A light transmitting portion of each of the flat portion 4a and the spherical portion 4b of the lens 4 is subjected to antireflective coating. Therefore, with the fact that the end of the optical fiber 2 is subjected to antireflective coating as described above, a noise caused by the reflection return light can be reduced to perform stable high-speed optical communications and the amount of transmitted light can be increased to improve the possibility of long-distance transmission.

A minimum value of a beam diameter of light collimated by the optical collimator 1 is equal to or smaller than 200 μm, preferably equal to or smaller than 141 μm, more preferably equal to or smaller than 100 μm. Therefore, the minimum value becomes approximately ½ of a beam diameter of light collimated by a conventional optical collimator of about 400 μm, preferably approximately 1/2.83, more preferably approximately ¼. When the optical collimator is used for an optical device, a cross sectional area of an inner part can be reduced to approximately ¼, preferably approximately ⅛, more preferably approximately 1/16. Thus, for example, the number of expensive Faraday rotors which are used for an optical isolator and can be taken from an original plate is approximately 4 times, preferably approximately 8 times, more preferably approximately 16 times, so there is an advantage in cost. Note that, when the minimum value of the beam diameter of light collimated by the optical collimator 1 is set to a value equal to or smaller than 100 μm, a low-cost bulk type optical isolator can be used for an inner part which includes a micro-electro-mechanical system (MEMS: combination of small electrical circuit and small mechanical structure) mechanism and has a small cross sectional area.

The optical collimator 1 is provided in a state in which the lens 4 is located outside the end of the fiber holding member 3, so it is unlikely to limit the size of the lens 4 and the curvature radius of the spherical portion 4b by the fiber holding member 3. The size of the optical collimator 1 can be reduced as compared with a conventional optical collimator. Therefore, the amount of expansion or the amount of contraction which is caused by the thermal expansion coefficient difference between the respective constituent elements can be reduced, with the result that it is unlikely to cause deviations in optical characteristics. Thus, it is possible to realize the high-performance optical collimator 1 whose size is reduced to a nonconventional size and environment resistance is excellent. In addition, the high-refractive index and small-size lens 4 including at least one flat portion 4a formed therein is bonded to be fixed to the flat portion 6a of the end of the second holding member 6 in the fiber holding member 3 with high angle precision. Therefore, the small optical collimator 1 can be produced in which light (light signal) which is outputted from the end of the optical fiber 2 and spread out is converted into parallel light through the lens 4 or parallel light is focused on the end of the optical fiber 2 through the lens 4. In particular, the small optical collimator 1 which is used to construct an optical fiber communication system of high-speed and large-capacity and has excellent optical characteristics can be produced.

In this case, the flat portion 6a of the end of the second holding member 6 is formed with a precision within ±0.5 degrees relative to the normal to the optical axis. Therefore, when the adjustment is performed at the time of bonding with the flat portion 4a of the lens 4, the tilt of the optical axis of the collimated light which is caused according to the precision can be eliminated. In addition to this, the unevenness of a thickness of the bonding agent is approximately 8 μm in maximum, so the reliability is not reduced. In the case where the flat portion 6a of the end of the second holding member 6 is formed with a precision within ±0.1 degrees relative to the normal to the optical axis, even when the flat portion 6a and the flat portion 4a of the lens 4 are fitted to each other such that the portions are in close contact with each other while being rubbed (for example, by only pressing for close contact), a tilt angle of the optical axis of the collimated light which is caused according to the precision becomes equal to or smaller than 0.1 degrees. Thus, preferable optical characteristics can be obtained for the optical collimator 1.

In the optical collimator 1, the first holding member 5 which has the end surface serving as the oblique surface 5a and holds the optical fiber 2 is inserted into the inner hole of the second holding member 6. In addition, the gap S is provided between the flat portion 4a of the lens 4 which is bonded to be fixed to the flat portion 6a of the end of the second holding member 6 and the oblique surface 5a of the end of the first holding member 5 which is opposed to the flat portion 4a. Therefore, the oblique surface 2a of the end of the optical fiber 2 can be freely positioned together with the first holding member 5 relative to the lens 4. Thus, a working distance (described in detail later) of the optical collimator 1 can be suitably controlled at the time of centering and fixation during bonding.

FIG. 2 shows an example of a schematic structure of an optical collimator serving as an optical component for optical communication according to a second embodiment of the present invention. An optical collimator 1 according to the second embodiment as shown in FIG. 2 is different from the optical collimator 1 according to the first embodiment as described above in a point that a lens 4 has a cylindrical shape whose center axis is aligned with the optical axis and includes a cylindrical portion 4c and a spherical portion 4b formed in an end thereof. Even in the case of the lens 4, a spherical lens is produced in advance as an original lens, apart of the spherical lens is removed by polishing processing or the like to form the cylindrical portion 4c, and a residual portion is used as the spherical portion 4b. Other structures are identical to those in the first embodiment. Therefore, in FIG. 2, the same reference symbols are provided to constituent elements common to those shown in FIG. 1 and the description is omitted. Even in the second embodiment, the same operation and effect as those in the first embodiment are obtained and thus the description is omitted for convenience.

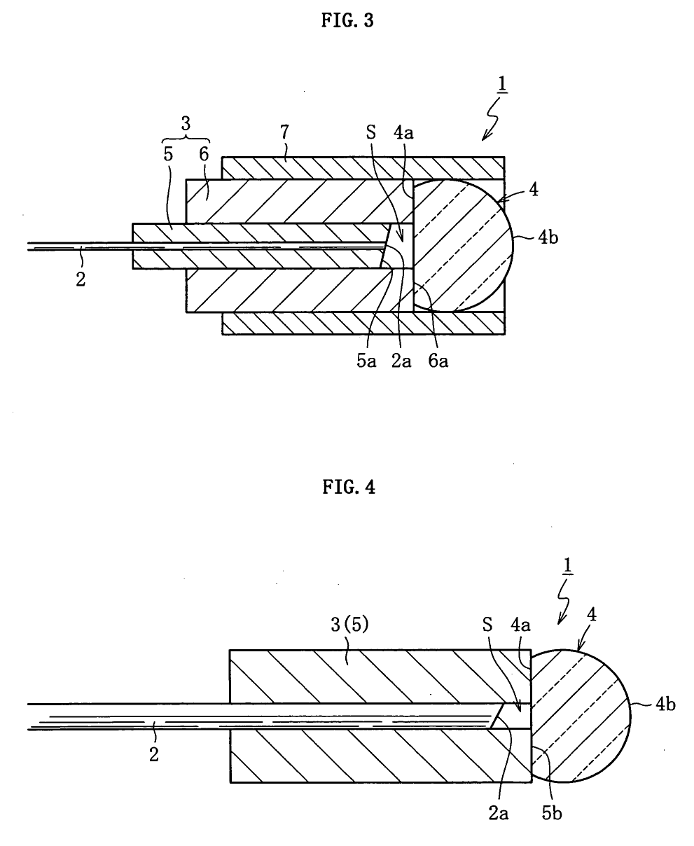

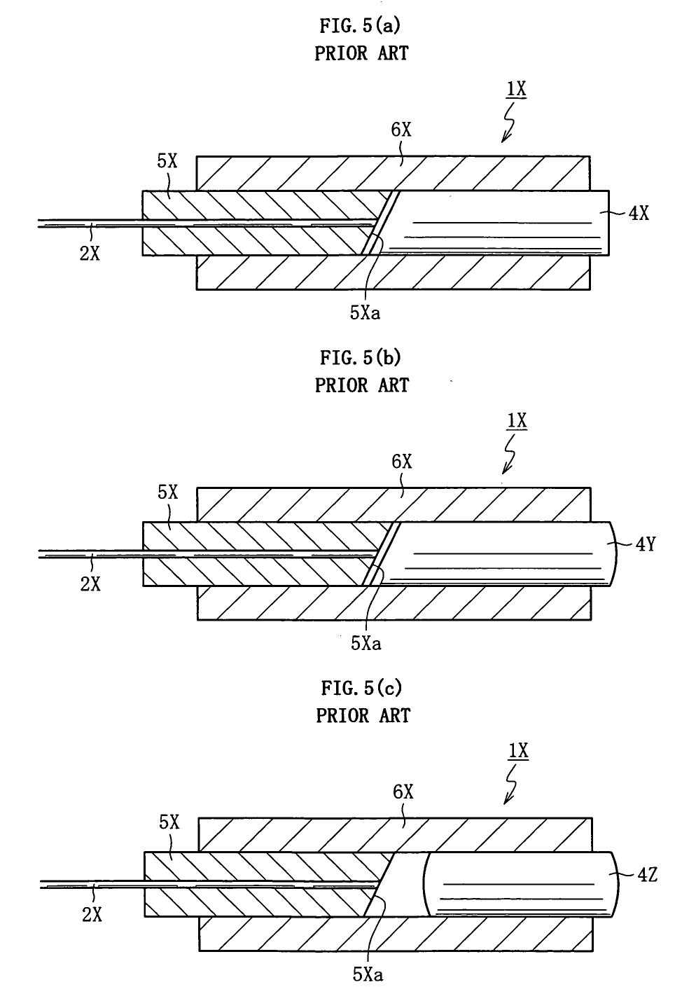

FIG. 3 shows an example of a schematic structure of an optical collimator serving as an optical component for optical communication according to a third embodiment of the present invention. An optical collimator 1 according to the third embodiment as shown in FIG. 3 is different from the optical collimator 1 according to the first embodiment as described above in a point that a cylindrical coating tube 7 is fitted to outer circumference sides of the second holding member 6 in the fiber holding member 3 and the lens 4. An inner circumference surface of the coating tube 7 is fixed to an outer circumference surface of the second holding member 6 by a bonding agent. In this case, the outside diameter of the second holding member 6 and the outside diameter of the lens 4 are substantially equal to each other. An end vertex of the lens 4 protrudes to a forward side in an optical direction relative to an end of the coating tube 7. A rear end of the second holding member 6 protrudes to a backward side in the optical direction relative to a rear end of the coating tube 7. When the coating tube 7 is provided in the outermost circumference of the optical collimator 1 as described above, the fiber holding member 3 (second holding member 6) and the lens 4 can be bonded to be fixed to each other while being centered by the coating tube 7. Therefore, the centering operation can be easily and automatically performed during the production of the optical collimator 1. In addition, there is an advantage in the case where a manufacturing cost is to be reduced. Other structures are identical to those in the first embodiment. Therefore, in FIG. 3, the same reference symbols are provided to constituent elements common to those shown in FIG. 1 and the description is omitted. Even in the third embodiment, the same operation and effect as those in the first embodiment are obtained except points particularly described here and thus the description is omitted for convenience. Note that it is also possible to fit the coating tube to the outermost circumference of the optical collimator 1 according to the second embodiment as shown in FIG. 2 as described above in the same manner.

FIG. 4 shows an example of a schematic structure of an optical collimator serving as an optical component for optical communication according to a fourth embodiment of the present invention. An optical collimator 1 according to the fourth embodiment as shown in FIG. 4 is different from the optical collimator 1 according to the first embodiment as described above in a point that the second holding member 6 of the fiber holding member 3 is eliminated. In addition, a flat portion 5b orthogonal to the optical axis is formed in the end of the first holding member 5 holding the optical fiber 2 in the inner hole thereof. The flat portion 5b and the flat portion 4a formed in the rear end of the lens 4 are bonded to be fixed to each other by a bonding agent. The gap S is provided between the oblique surface 2a of the end of the optical fiber 2 and the flat portion 4a of the lens 4 such that the optical fiber 2 can be moved in the axis direction to be freely positioned. Therefore, the number of parts is reduced to simplify the structure and a material cost is saved. Other structures are identical to those in the first embodiment. Therefore, in FIG. 4, the same reference symbols are provided to constituent elements common to those shown in FIG. 1 and the description is omitted. Even in the fourth embodiment, the same operation and effect as those in the first embodiment are obtained except points particularly described here and thus the description is omitted for convenience. In the fourth embodiment, the shape of the lens 4 may be identical to that in the second embodiment as shown in FIG. 2. The coating tube may be fitted to the outermost circumference of the optical collimator 1 in the same manner as the third embodiment shown in FIG. 3.

In each of the above-mentioned embodiments, the present invention is applied to the optical collimator. The present invention can be applied in the same manner to another optical component for optical communication which includes an optical fiber, a fiber holding member, and a lens.

### EXAMPLE 1

In Example 1 of the present invention, the optical collimator 1 having the structure shown in FIG. 1 (first embodiment) was produced. In the optical collimator 1 according to Example 1, the first holding member 5 was made of glass and had an outer diameter of 0.25 mm, an inner diameter of 0.126 mm, and the entire length of 3 mm. The end surface of the first holding member 5 was polished such that the end surface was tilted at a tilt angle of 8 degrees relative to the normal to the optical axis, thereby forming the oblique surface 5a. The optical fiber 2 whose end surface was polished together with the end surface of the first holding member 5 (before the formation of the oblique surface 5a) was held in the inner hole of the first holding member 5. The second holding member 6 of the optical collimator 1 was made of glass and had an outer diameter of 1 mm, an inner diameter of 0.255 mm, and the entire length of 2 mm. The second holding member 6 was fitted to the outer circumference side of the first holding member 5. The lens 4 of the optical collimator 1 was formed by using, as an original lens, a spherical lens which had a diameter of 1 mm and was made of optical glass RH-21 (which is produced by Nippon Electric Glass Co., Ltd.) whose refractive index was substantially uniform. A part of the spherical lens was subjected to polishing processing or the like such that a distance between the flat portion 4a and the end vertex of the spherical portion 4b became 0.7 mm. The flat portion 6a of the end of the second holding member 6 and the flat portion 4a of the rear end of the lens 4 were bonded to be fixed to each other in a contact state by a bonding agent. An antireflective coating was formed on at least a light transmitting portion of each of the flat portion 4a of the lens 4, the spherical portion 4b thereof, and the oblique surface 2a of the end of the optical fiber 2 to reduce the reflection return light. In order to correctly operate the optical collimator, the-oblique surface 2a of the end of the optical fiber 2 and the flat portion 4a of the rear end of the lens 4 were separated from each other by 0.16 mm which was an optically suitable distance.

With respect to the optical collimator 1 having the above-mentioned structure according to Example 1 of the present invention, an insertion loss, the amount of reflection attenuation (also called return loss), and the beam diameter of collimated light were measured. Light with a wavelength of 1550 nm was used for the measurement. The insertion loss was measured in a state in which two optical collimators, each of which was the optical collimator 1, were opposed to each other at a working distance of 5 mm. The working distance means a spatial distance between the end vertexes of the spherical portions 4b of the lenses 4 in a case where the optical collimators 1 are opposed to each other. A result obtained by the above-mentioned measurement is shown in Table 1 below.

TABLE 1

| Insertion loss | Return Loss | Beam diameter |
|---|---|---|
| 0.2 dB or less | −50 dB or less | 0.1 mm |

As can be seen from the insertion loss and the return loss shown in Table 1, the performance necessary and sufficient for the optical collimator whose beam diameter was approximately 0.1 mm was obtained. Therefore, it was confirmed that there was no practical problem. In the above-mentioned measurement, the working distance was set to 5 mm. The optical collimator 1 according to Example 1 had the structure in which the end of the optical fiber 2 can be brought close to and separated from the flat portion 4a of the lens 4, so the working distance can be freely adjusted in, for example, a range of approximately 1 mm to 6 mm.

### EXAMPLE 2

In Example 2 of the present invention, the optical collimator 1 having the structure shown in FIG. 2 (second embodiment) was produced. In the optical collimator 1 according to Example 2, for example, a size and a material of each portion in each of the first holding member 5 and the second holding member 6 were identical to those in Example 1 described above. The lens 4 of the optical collimator 1 was formed by using, as an original lens, a spherical lens which had a diameter of 2 mm and was made of optical glass RH-21 (which is produced by Nippon Electric Glass Co., Ltd.) whose refractive index was substantially uniform. Apart of the spherical lens was subjected to polishing processing or the like such that a distance between the flat portion 4a and the end vertex of the spherical portion 4b became 1.8 mm. The bonding state between the second holding member 6 and the lens 4 and the fact that the antireflective coating was formed in place are identical to those in Example 1 described above. In order to correctly operate the optical collimator, the oblique surface 2a of the end of the optical fiber 2 and the flat portion 4a of the lens 4 were separated from each other by 0.12 mm which is an optically suitable distance.

With respect to the optical collimator 1 having the above-mentioned structure according to Example 2 of the present invention, the insertion loss, the return loss, and the beam diameter of collimated light, which were identical to the above-mentioned items, were measured. Light with a wavelength of 1550 nm was used for the measurement. The insertion loss was measured in a state in which two optical collimators, each of which was the optical collimator 1, were opposed to each other at a working distance of 10 mm. A result obtained by the above-mentioned measurement is shown in Table 2 below.

TABLE 2

| Insertion loss | Return Loss | Beam diameter |
|---|---|---|
| 0.2 dB or less | −50 dB or less | 0.2 mm |

As can be seen from the insertion loss and the return loss shown in Table 2, the performance necessary and sufficient for the optical collimator whose beam diameter was approximately 0.2 mm was obtained. Therefore, it was confirmed that there was no practical problem. In the above-mentioned measurement, the working distance was set to 10 mm. The optical collimator 1 according to Example 2 had the structure in which the end of the optical fiber 2 can be brought close to and separated from the flat portion 4a of the lens 4, so the working distance can be freely adjusted in, for example, a range of approximately 5 mm to 15 mm. In addition, in the case of the optical collimator 1 according to Example 2, when a portion which does not transmit light, of the original lens which is the spherical lens whose diameter is 2 mm is subjected to centering processing, the size of the lens 4 can be reduced until a cylindrical diameter reaches 1 mm and the working distance can be lengthened as described above.

### EXAMPLE 3

In Example 3 of the present invention, the optical collimator 1 having the structure shown in FIG. 3 (third embodiment) was produced. In the optical collimator 1 according to Example 3, for example, a size and a material of each portion in each of the first holding member 5 and the second holding member 6 were identical to those in Example 1 or 2 described above. The lens 4 of the optical collimator 1 was formed by using, as an original lens, a spherical lens which had a diameter of 1 mm and was made of optical glass RH-21 (which is produced by Nippon Electric Glass Co., Ltd.) whose refractive index was substantially uniform. A part of the spherical lens was subjected to polishing processing or the like such that a distance between the flat portion 4a and the end vertex of the spherical portion 4b became 0.7 mm. The coating tube 7 of the optical collimator 1 was made of glass and had an outer diameter of 1.4 mm, an inner diameter of 1 mm, and the entire length of 3 mm. While the flat portion 6a of the end of the second holding member 6 and the flat portion 4a of the rear end of the lens 4 were in contact with each other, the second holding member 6 and the lens 4 were inserted into the inner hole of the coating tube 7 to perform semi-automatic centering in the direction of the normal to the optical axis (coaxial direction) and then bonded to be fixed thereto by a bonding agent. The fact that the antireflective coating was formed in place was identical to that in each of Examples 1 and 2 described above. In order to correctly operate the optical collimator, the oblique surface 2a of the end of the optical fiber 2 and the flat portion 4a of the lens 4 were separated from each other by 0.16 mm which was an optically suitable distance.

With respect to the optical collimator 1 having the above-mentioned structure according to Example 3 of the present invention, the insertion loss, the return loss, and the beam diameter of collimated light, which were identical to the above-mentioned items, were measured. Light with a wavelength of 1550 nm was used for the measurement. The insertion loss was measured in a state in which two optical collimators, each of which was the optical collimator 1, were opposed to each other at a working distance of 5 mm. A result obtained by the above-mentioned measurement is shown in Table 3 below.

TABLE 3

| Insertion loss | Return Loss | Beam diameter |
|---|---|---|
| 0.2 dB or less | −50 dB or less | 0.1 mm |

As can be seen from the insertion loss and the return loss shown in Table 3, the performance necessary and sufficient for the optical collimator whose beam diameter was approximately 0.1 mm was obtained. Therefore, it was confirmed that there was no practical problem. In the above-mentioned measurement, the working distance was set to 5 mm. The optical collimator 1 according to Example 3 had the structure in which the end of the optical fiber 2 can be brought close to and separated from the flat portion 4a of the lens 4, so the working distance can be freely adjusted in, for example, a range of approximately 1 mm to 6 mm. In addition, in the case of the optical collimator 1 according to Example 3, when the lens 4 and the second holding member 6, each of which has an outer diameter controlled with high precision, are inserted into the coating tube 7 having an inner diameter controlled with high precision, semi-automatic centering in the direction of the normal to the optical axis (coaxial direction) can be performed. Therefore, time and effort for centering can be significantly reduced. When the coating tube 7 is used, a bonding portion between the flat portion 6a of the second holding member 6 and the flat portion 4a of the lens 4 can be protected to increase a mechanical strength.

### EXAMPLE 4

In Example 4 of the present invention, the optical collimator 1 having the structure shown in FIG. 1 (first embodiment) was produced. In the optical collimator 1 according to Example 4, the first holding member 5 was made of glass and had an outer diameter of 0.25 mm, an inner diameter of 0.126 mm, and the entire length of 5 mm. The end surface of the first holding member 5 was polished such that the end surface was tilted at a tilt angle of 8 degrees relative to the normal to the optical axis, thereby forming the oblique surface 5a. The optical fiber 2 whose end surface was polished together with the end surface of the first holding member 5 (before the formation of the oblique surface 5a) was held in the inner hole of the first holding member 5. The second holding member 6 of the optical collimator 1 was made of glass and had an outer diameter of 1 mm, an inner diameter of 0.255 mm, and the entire length of 4 mm. The second holding member 6 was fitted to the outer circumference side of the first holding member 5. Other structures were identical to those in Example 1 described above.

With respect to the optical collimator 1 having the above-mentioned structure according to Example 4 of the present invention, the insertion loss, the return loss, and the beam diameter of collimated light, which were identical to the above-mentioned items, were measured. Light with a wavelength of 1550 nm was used for the measurement. The insertion loss was measured in a state in which two optical collimators, each of which is the optical collimator 1, were opposed to each other at a working distance of 5 mm. A result obtained by the above-mentioned measurement was identical to that in Example 1 described above and thus the table and its description are omitted here.

### EXAMPLE 5

In Example 5 of the present invention, the optical collimator 1 having the structure shown in FIG. 1 (first embodiment) was produced. In the optical collimator 1 according to Example 5, for example, a size and a material of each portion in each of the first holding member 5 and the second holding member 6 were identical to those in Example 1 described above. The lens 4 of the optical collimator 1 was formed by using, as an original lens, a spherical lens which had a diameter of 1 mm and was made of optical glass MK-18 (which is produced by Nippon Electric Glass Co., Ltd.) whose refractive index was substantially uniform. A part of the spherical lens was subjected to polishing processing or the like such that a distance between the flat portion 4a and the end vertex of the spherical portion 4b became 0.7 mm. The bonding state between the second holding member 6 and the lens 4 and the fact that the antireflective coating was formed in place were identical to those in Example 1 described above. In order to correctly operate the optical collimator, the oblique surface 2a of the end of the optical fiber 2 and the flat portion 4a of the lens 4 were separated from each other by 0.25 mm which is an optically suitable distance.

With respect to the optical collimator 1 having the above-mentioned structure according to Example 5 of the present invention, the insertion loss, the return loss, and the beam diameter of collimated light, which were identical to the above-mentioned items, were measured. Light with a wavelength of 1550 nm was used for the measurement. The insertion loss is measured in a state in which two optical collimators, each of which is the optical collimator 1, were opposed to each other at a working distance of 5 mm. A result obtained by the above-mentioned measurement is shown in Table 2 below.

TABLE 4

| Insertion loss | Return Loss | Beam diameter |
|---|---|---|
| 0.2 dB or less | −50 dB or less | 0.12 mm |

As can be seen from the insertion loss and the return loss shown in Table 4, the performance necessary and sufficient for the optical collimator whose beam diameter was approximately 0.12 mm was obtained. Therefore, it was confirmed that there was no practical problem. In the above-mentioned measurement, the working distance was set to 5 mm. The optical collimator 1 according to Example 5 had the structure in which the end of the optical fiber 2 can be close to and separated from the flat portion 4a of the lens 4, so the working distance can be freely adjusted in, for example, a range of approximately 1 mm to 8 mm.

1. An optical component for optical communication, comprising:
a fiber holding member having a flat portion formed in an end thereof, for holding an optical fiber; and
a lens which is located on an optical path extending from an end of the optical fiber and attached to the fiber holding member, having a flat portion formed in a rear end of the lens,
wherein the flat portion of the lens is bonded to be fixed to the flat portion of the fiber holding member such that the flat portion of the lens is opposed to the end of the optical fiber, and the flat portion of the lens and the end of the optical fiber are separated from each other with a gap provided therebetween.

2. An optical component for optical communication according to claim 1, wherein the optical component for optical communication comprises an optical collimator for converting light which is outputted from the optical fiber and spread out into parallel light through the lens or for focusing parallel light on the optical fiber through the lens.

3. An optical component for optical communication according to claim 1, wherein the optical fiber comprises in the end thereof an oblique surface tilted relative to an optical axis.

4. An optical component for optical communication according to claim 2, wherein a minimum value of a beam diameter of the parallel light is equal to or smaller than 200 μm.

5. An optical component for optical communication according to claim 1, wherein:
the fiber holding member comprises:
a first holding member including an inner hole, for holding the optical fiber in the inner hole; and
a second holding member which is fitted to an outer circumference side of the first holding member and includes a flat portion formed in an end of the second holding member; and
the flat portion formed in the rear end of the lens is bonded to be fixed to the flat portion formed in the end of the second holding member such that the flat portion of the lens is opposed to an end of the first holding member.

6. An optical component for optical communication according to claim 5, wherein:
the first holding member comprises in the end thereof an oblique surface tilted relative to an optical axis; and
the oblique surface is formed to be identical to the oblique surface formed in the end of the optical fiber.

7. An optical component for optical communication according to claim 1, wherein the lens comprises an end surface which includes a convex curved surface.

8. An optical component for optical communication according to claim 7, wherein the convex curved surface of the lens comprises a spherical surface.

9. An optical component for optical communication according to claim 1, wherein the lens comprises a spherical lens which is partially processed.

10. An optical component for optical communication according to claim 9, wherein the flat portion of the lens is separated from an end vertex of a spherical portion thereof at a distance L which is equal to or longer than a length of a radius R of the spherical lens.

11. An optical component for optical communication according to claim 1, wherein the flat portion of the lens has at least a light transmitting surface subjected to antireflective coating.

12. An optical component for optical communication according to claim 1, wherein the lens comprises an end surface having at least a light transmitting surface subjected to antireflective coating.

13. An optical component for optical communication according to claim 1, wherein the lens comprises a glass material whose refractive index is equal to or larger than 1.7.

14. An optical component for optical communication according to claim 1, further comprising a coating tube fitted to an outer circumference side of the fiber holding member and an outer circumference side of the lens therealong,
wherein the fiber holding member has an outer diameter substantially equal to an outer diameter of the lens.

15. An optical component for optical communication according to claim 2, wherein the optical fiber comprises in the end thereof an oblique surface tilted relative to an optical axis.

16. An optical component for optical communication according to claim 3, wherein a minimum value of a beam diameter of the parallel light is equal to or smaller than 200 μm.

17. An optical component for optical communication according to claim 15, wherein a minimum value of a beam diameter of the parallel light is equal to or smaller than 200 μm.

18. An optical component for optical communication according to claim 2, wherein:
the fiber holding member comprises:
a first holding member including an inner hole, for holding the optical fiber in the inner hole; and
a second holding member which is fitted to an outer circumference side of the first holding member and includes a flat portion formed in an end of the second holding member; and
the flat portion formed in the rear end of the lens is bonded to be fixed to the flat portion formed in the end of the second holding member such that the flat portion of the lens is opposed to an end of the first holding member.

19. An optical component for optical communication according to claim 3, wherein:
the fiber holding member comprises:
a first holding member including an inner hole, for holding the optical fiber in the inner hole; and
a second holding member which is fitted to an outer circumference side of the first holding member and includes a flat portion formed in an end of the second holding member; and
the flat portion formed in the rear end of the lens is bonded to be fixed to the flat portion formed in the end of the second holding member such that the flat portion of the lens is opposed to an end of the first holding member.

20. An optical component for optical communication according to claim 15, wherein:
the fiber holding member comprises:
a first holding member including an inner hole, for holding the optical fiber in the inner hole; and
a second holding member which is fitted to an outer circumference side of the first holding member and includes a flat portion formed in an end of the second holding member; and
the flat portion formed in the rear end of the lens is bonded to be fixed to the flat portion formed in the end of the second holding member such that the flat portion of the lens is opposed to an end of the first holding member.
